(19) United States
(12) Patent Application Publication
(10) Pub. No.: US 2008/0096412 A1
(43) Pub. Date: Apr. 24, 2008

(54) Angled edge card connector with low profile

(75) Inventors: Edmund Poh, Naperville, IL (US); James L. McGrath, Bloomingdale, IL (US); Ramesh Srinivasa Rao, Singapore (SG); Lay Peng Lim, Singapore (SG); Han Guan Johnson Tan, Singapore (SG)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 11/584,105

(22) Filed: Oct. 20, 2006

(51) Int. Cl. H01R 13/62

(52) U.S. Cl. 439/326

(57) ABSTRACT

The edge card connector provides communication between a daughterboard and a printed wiring board. The edge card connector is mounted to a printed wiring board and provides a slot which is angled relative to the printed wiring board. Upper terminals extend from an upper wall of the slot to the printed wiring board and lower terminals extend from a lower wall of the slot to provide communication between the daughterboard and the printed wiring board. In order to provide a low profile daughterboard-connector combination, portions of the connector housing below the plane of the slot have been minimized. In addition, portions of the lower terminals are provided above the plane of the slot in order to minimize the dimensions of the connector housing below the plane of the slot.

### FIELD OF THE INVENTION

This invention relates to edge card connectors, and more particularly, to a low profile angled edge card connector.

### BACKGROUND OF THE INVENTION

Angled edge card connectors are used to provide connection between printed wiring boards and daughterboards. An example of such prior art angled edge connectors is shown and described in U.S. Pat. No. 5,964,606. A typical angled edge connector is mounted to a printed wiring board and defines a slot to receive the daughterboard. The daughterboard to be inserted in the connector slot includes an upper surface and a lower surface.

A plurality of terminals of the edge connectors provide an electrical connection between the daughterboard and the printed wiring board. Upper rows of terminals are provided above the slot to mate with contact pads on the upper surface of the daughterboard and lower rows of terminals are provided below the slot to mate with contact pads on the lower surface of the daughterboard. Each terminal includes a lock portion, a working portion extending from the lock portion, and a contact corner. Each lock portion is fixed to the housing to secure the terminal within the housing. The working portion provides a biasing force to bias the daughterboard within the connector slot. The contact corners mate with the contact pads of the daughterboard. In order to maintain a connection between an upper terminal and an upper contact pad, the lock portion, or barb, of the terminal is secured to the housing on a plane above the slot and the working portion is angled downwardly and rearwardly from the lock portion to the contact corner. In order to maintain a connection between a lower terminal and a lower contact pad, the lock portion is secured to the housing on a plane below the slot and the working portion is angled upwardly and rearwardly from the lock portion to the contact corner. As the daughterboard is inserted into the slot, the connector housing provides resistance against an upward motion of the upper terminals and downward motion of the lower terminals. Thus, a spring like action is provided by the working portions of the terminals to bias the daughterboard toward the slot thus ensuring that a connection between the terminals and the contact pads is formed.

Typically, a plurality of the connectors for receiving daughterboards are attached to another printed wiring board, commonly referred to as a motherboard. Spacing is provided between adjacent connectors to provide an air gap between adjacent daughterboards for the dissipation of heat. By providing an angled slot, the amount of real estate utilized on the printed wiring board is reduced and at the same time the height of the daughterboard-connector combination is minimized. One type of daughterboard typically used with an edge connector is a fully buffered dual in-line memory modules (FB DIMM). One such DIMM has a thickness of 10.55 mm and a length of 30.55 mm. When inserted in the slot, a gap is provided between the lowest most portion of the daughterboard and the motherboard.

As the profile of the devices in which these connectors and daughterboards are used becomes even smaller, there is a desire to further reduce the height or profile of the connector-daughterboard combination. These low profile devices include, for example, lap top computers.

### SUMMARY OF THE INVENTION

An edge connector is provided which accomplishes a reduction in the profile of the connector-daughterboard combination, without requiring any modifications to the daughterboard. The connector provides a housing including an offset slot for receiving the tongue of the daughterboard, a plurality of terminal passageways and a plurality of terminals mounted within the terminal passageways. The terminals extend from the printed wiring board to the slot and are configured to reduce the height of the terminals without reducing the reliability of the connection between the terminals and the contact pads of the daughterboard. Guide members are provided to assist a user with the insertion of the daughterboard in the slot.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a front perspective view of a connector which incorporates features of the present invention with a number of terminals removed for clarity and with a daughter card mounted therein, the connector being mounted to a printed wiring board;

FIG. 2 is a front perspective view of the connector with a number of the terminal removed for clarity and with the ejection latches shown in an open position, the connector being mounted to a printed wiring board;

FIG. 3 is a rear perspective view of the connector with a number of the terminals removed for clarity and with the ejection latches shown in an open position, the connector being mounted to a printed wiring board;

FIG. 4 is a rear elevational view of the connector with a number of the terminals removed for clarity and with the ejection latches shown in an open position, the connector being mounted to a printed wiring board;

FIG. 5 is a left side elevational view of the connector mounted to a printed wiring board shown without the ejection latches;

FIG. 6 is a rear elevational view of the connector mounted to a printed wiring board shown without ejection latches;

FIG. 6a is an enlarged view of a portion of the connector as shown in FIG. 6;

FIG. 7 is a cross-sectional view of the connector mounted to a printed wiring board shown without the ejection latches or the tail aligner;

FIG. 8 is a cross-sectional view of the connector mounted to a printed wiring board shown without the ejection latches and with a tail aligner;

FIG. 9 is a cross-sectional view of the connector mounted to a printed wiring board with a daughter card mounted therein;

FIG. 10 is a cross-sectional view of the connector, showing first upper and lower rows of terminals, mounted to a printed wiring board without a tail aligner;

FIG. 11 is a cross-sectional view of the connector, showing first upper and lower rows of terminals, mounted to a printed wiring board with a tail aligner;

FIG. 12 is a cross-sectional view of the connector, showing first upper and lower rows of terminals, mounted to a printed wiring board with a tail aligner and with a daughterboard mounted therein;

FIG. 13 is a cross-sectional view of the connector, showing second upper and lower rows of terminals, mounted to a printed wiring board without a tail aligner;

FIG. 14 is a cross-sectional view of the connector, showing second upper and lower rows of terminals, mounted to a printed wiring board with a tail aligner;

FIG. 15 is a cross-sectional view of the connector, showing second upper and lower rows of terminals, mounted to a printed wiring board with a tail aligner and with a daughterboard mounted therein;

FIG. 16 is a front perspective view of the connector with a daughter card mounted therein and a portion of the connector removed for clarity;

FIG. 16a is an enlarged view of a portion of the connector as shown in FIG. 16;

FIG. 16b is an enlarged view of a portion of the connector as shown in FIG. 16;

FIG. 17a is a side elevational view of the connector mounted on a printed wiring board and a daughter card ready for insertion into the connector;

FIG. 17b is a side elevational view of the connector mounted on a printed wiring board and a daughter card aligned for insertion into the connector;

FIG. 17c is a side elevational view of the connector mounted on a printed wiring board and a daughter card in connect with the connector;

FIG. 18 is a cross-sectional view of the connector, along with a daughterboard aligned for insertion into the connector;

FIG. 18a is an enlarged view of a portion of the connector as shown in FIG. 18;

FIG. 19 is a cross-sectional view of the connector, along with a daughterboard inserted therein;

FIG. 19a is an enlarged view of a portion of the connector as shown in FIG. 19;

FIG. 20 is a cross-sectional view of the connector, along with a misaligned daughterboard to be inserted therein;

FIG. 20a is an enlarged view of the connector as shown in FIG. 20;

FIG. 21 is front perspective view of a portion of the connector without the tail aligner;

FIG. 22 is a front perspective view of portion of the connector with the tail aligner;

FIG. 22a is a perspective view of a portion of the connector as shown in FIG. 22;

FIG. 22b is a cross-sectional view of a portion of the tail aligner;

FIG. 22b is a cross-sectional view of a portion of the tail aligner; and

FIG. 22c is a cross-sectional view of a portion of the tail aligner.

### DETAILED DESCRIPTION OF THE ILLUSTRATED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

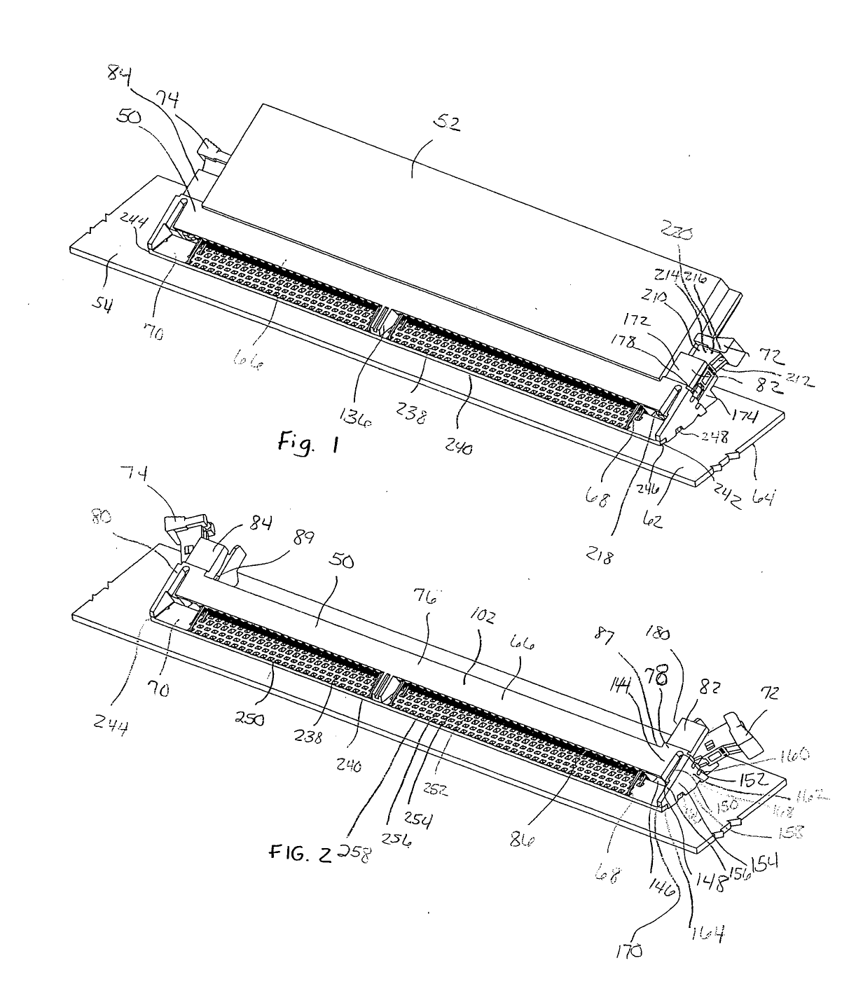

As best shown in FIGS. 1-4, the connector 50 is an angled edge card connector which receives a daughterboard 52, such as, for example, a fully buffered dual in-line memory module (FB DIMM) and is mounted to a printed wiring board 54. The printed wiring board 54 includes an upper surface 62 and a lower surface 64. As best shown in FIG. 9, the daughterboard 52 generally includes an upper component area 55, a lower component area 56, and a printed wiring board 58 between the upper and lower component areas 55, 56. A portion of the printed wiring board 58 extends beyond the front ends of the component areas 55, 56 to provide a tongue 60. One such DIMM has a thickness (t) of 10.55 mm, a length (l) of 30.55 mm, and a height (h) of 22 mm when provided at an angle of 28.5 degrees relative to the printed wiring board 54.

The connector 50 includes a dielectric housing 66, a plurality of terminals 271, 273, 275, 277 extending through the housing 66, a tail aligner 70 attached to the housing 66 through which the terminals 271, 273, 275, 277 pass, and ejection latches 72, 74 for removing the daughterboard 52 from the connector 50.

The housing 66 includes a central base portion 76, a right base portion 78, a left base portion 80, a right tower 82, and a left tower 84.

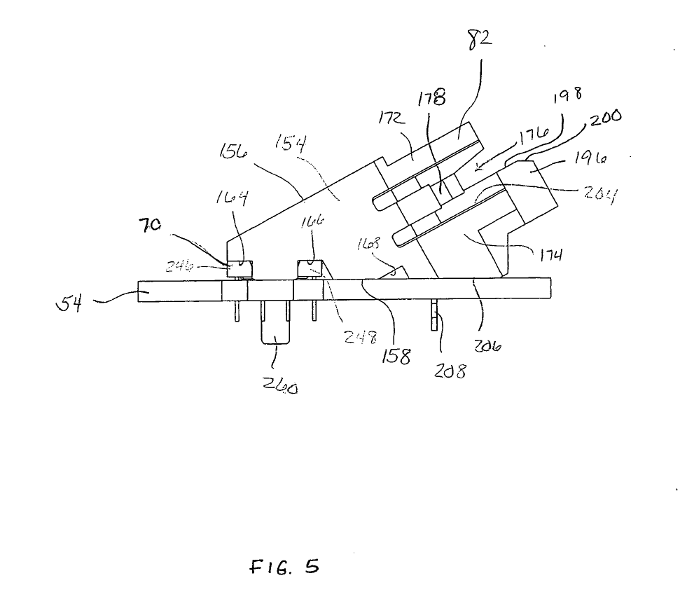

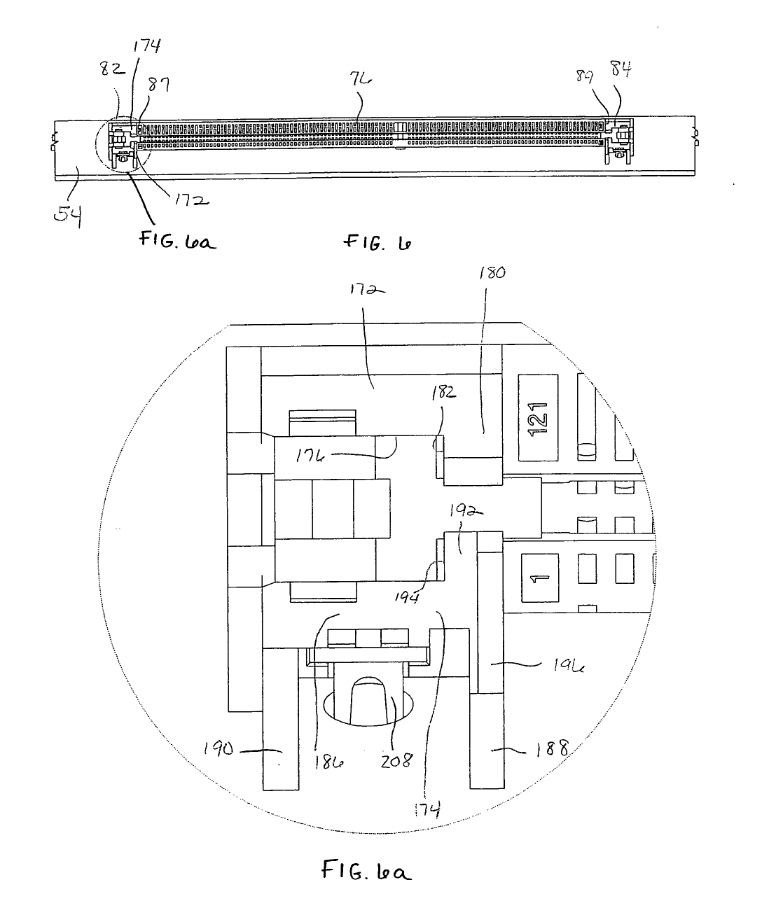

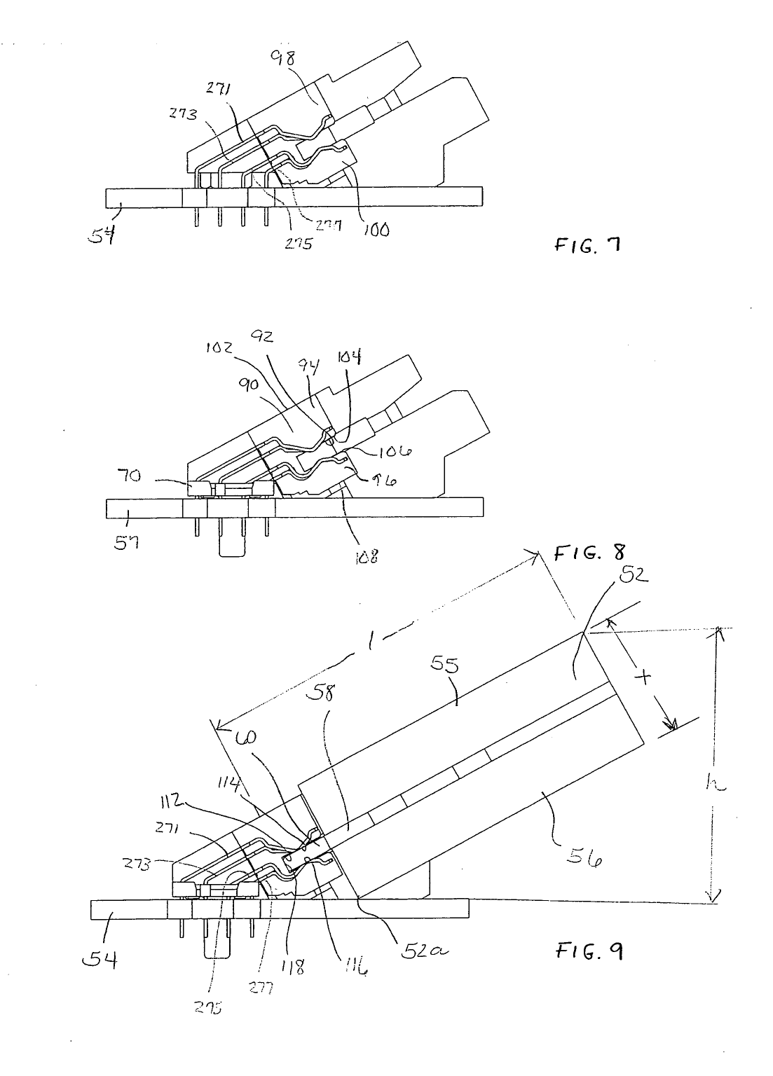

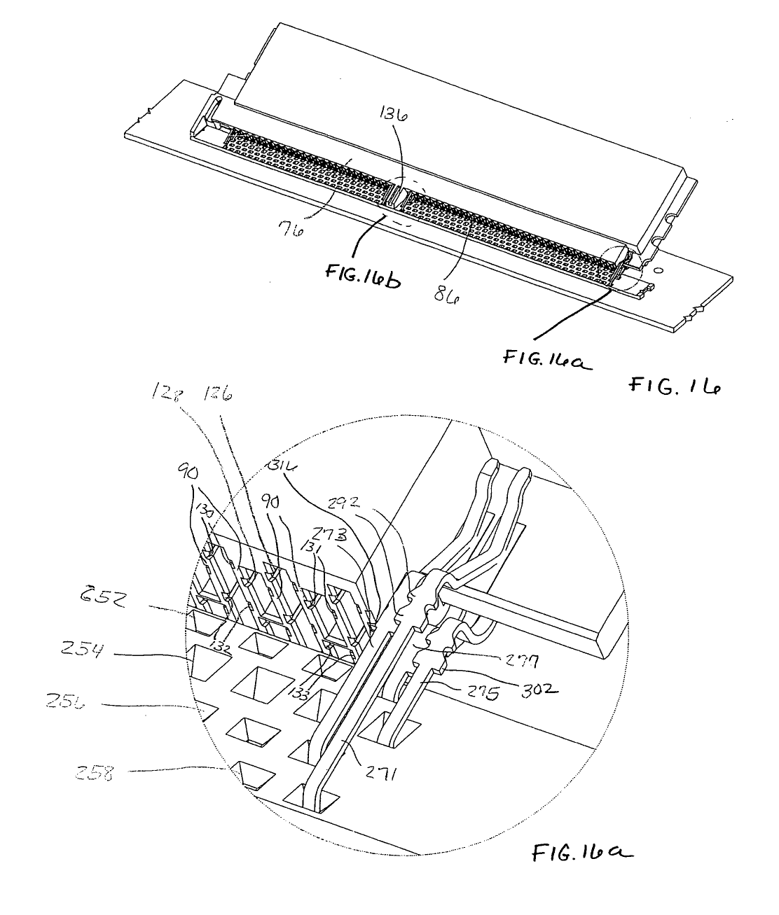

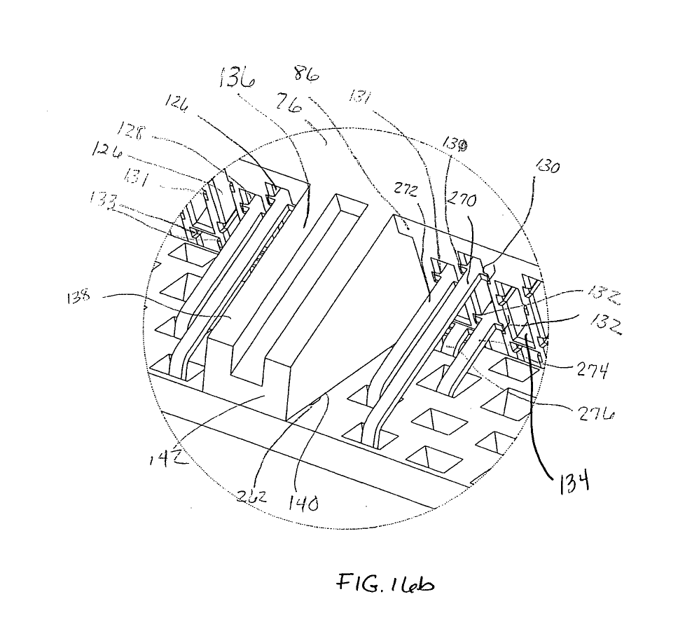

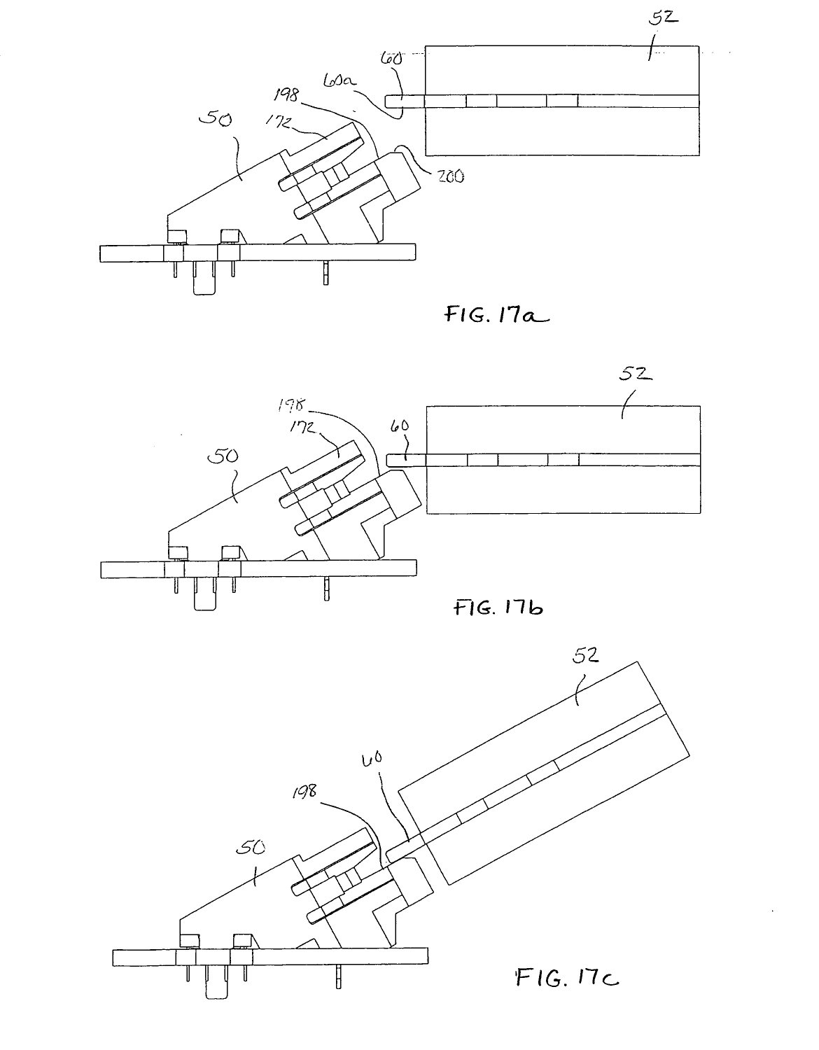

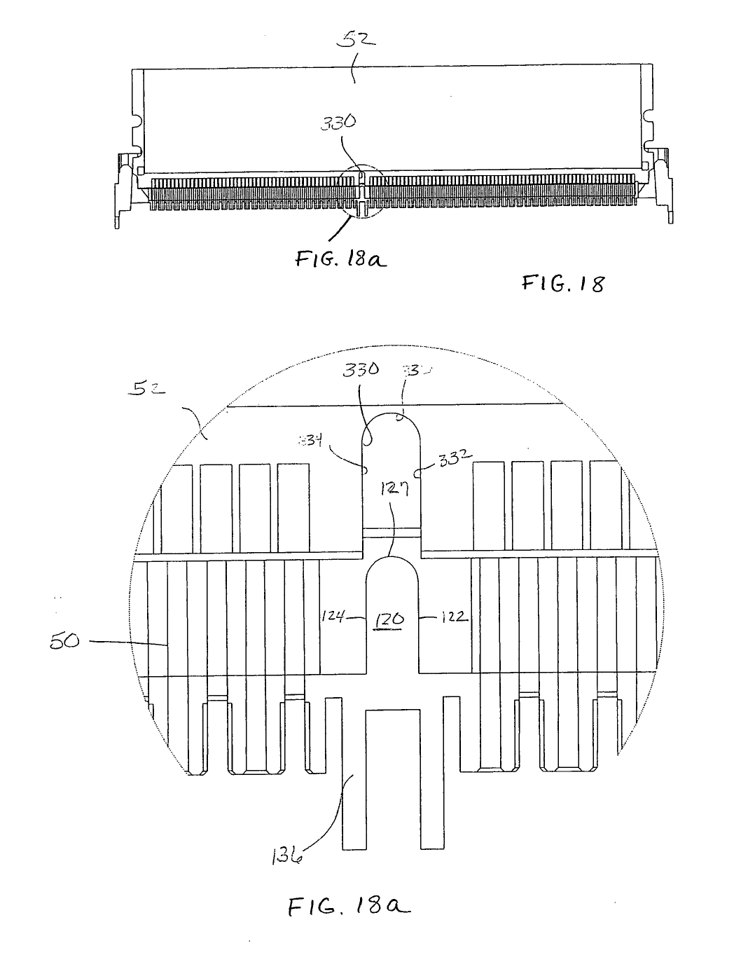

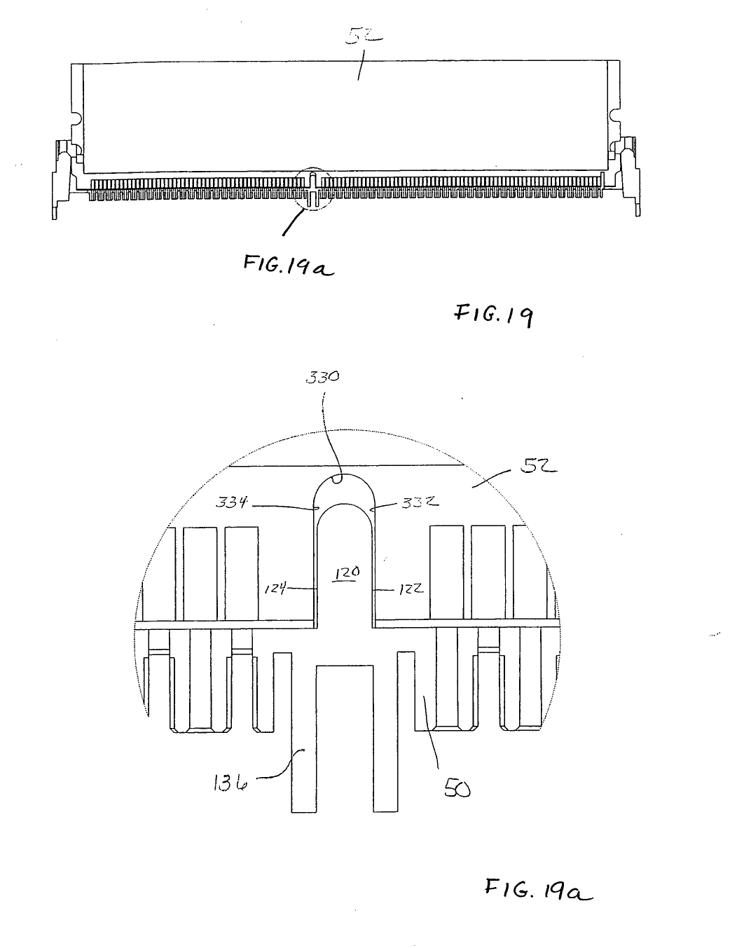

As best shown in FIGS. 2 and 4, the central base portion 76 is generally rectangularly-shaped and provides a front end 86, a rear, or daughterboard insertion, end 88, a right end 87, and a left end 89. A plurality of spaced apart and parallel upright walls 90 shown in FIG. 4 extend from the front end 86 to the rear end 88 to form terminal receiving passages between adjacent walls 90. As shown in FIGS. 8, 11 and 14, a forwardly extending notch 92 is provided at the rear end of each upright wall 90 to provide an upper portion 94 and lower wall portion 96 for each wall 90. As shown in FIG. 4, an upper rail 98 is provided by the upper wall portions 94 and a lower rail 100 is provided by the lower wall portions 96.

The upper rail 98 includes a top wall 102 and a rib 104, each extending from the right end 87 to the left end 89. The top wall 102 is generally rectangularly-shaped and is provided at upper ends of the upper wall portions 94. The top wall 102 extends from rear ends of the upper wall portions 94 to front ends of the upper wall portions 94 and is generally perpendicular to the upper wall portions 94. The rib 104 is provided at the rear ends of the upper wall portions 94 and is spaced from the top wall 102. The rib 104 extends along the lower ends of the upper wall portions 94.

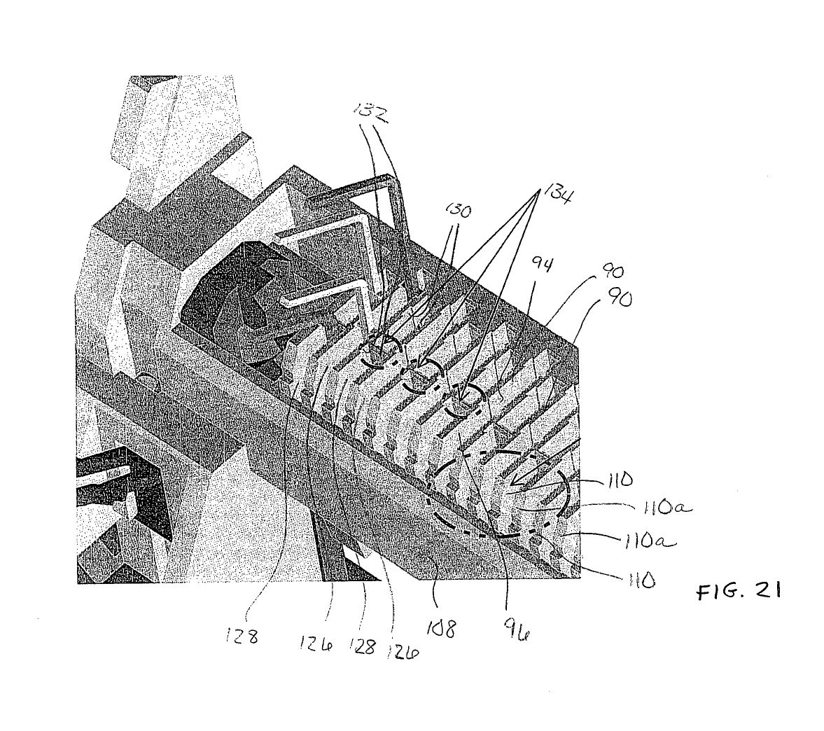

The lower rail 100 includes a rib 106 and a bottom wall 108. The rib 106 is provided at the rear ends of the lower wall portions 96. The rib 106 extends along the upper ends of the lower wall portions 96. The bottom wall 108 is generally rectangularly-shaped and is provided at the lower ends of the lower wall portions 96 and is generally perpendicular to the lower wall portions 96. As best shown in FIG. 21, the bottom wall 108 extends from the rear ends of the lower wall portions 96 toward the front ends of the lower wall portions 96, but is spaced therefrom to provide free ends 110 of the lower wall portions 96. An angled surface 110a is provided at each free end 110 of the lower wall portions 96 proximate the front end 86 of the connector 20. The surface 110a extends upwardly and rearwardly from bottom edges of the front ends of the bottom wall portions 96.

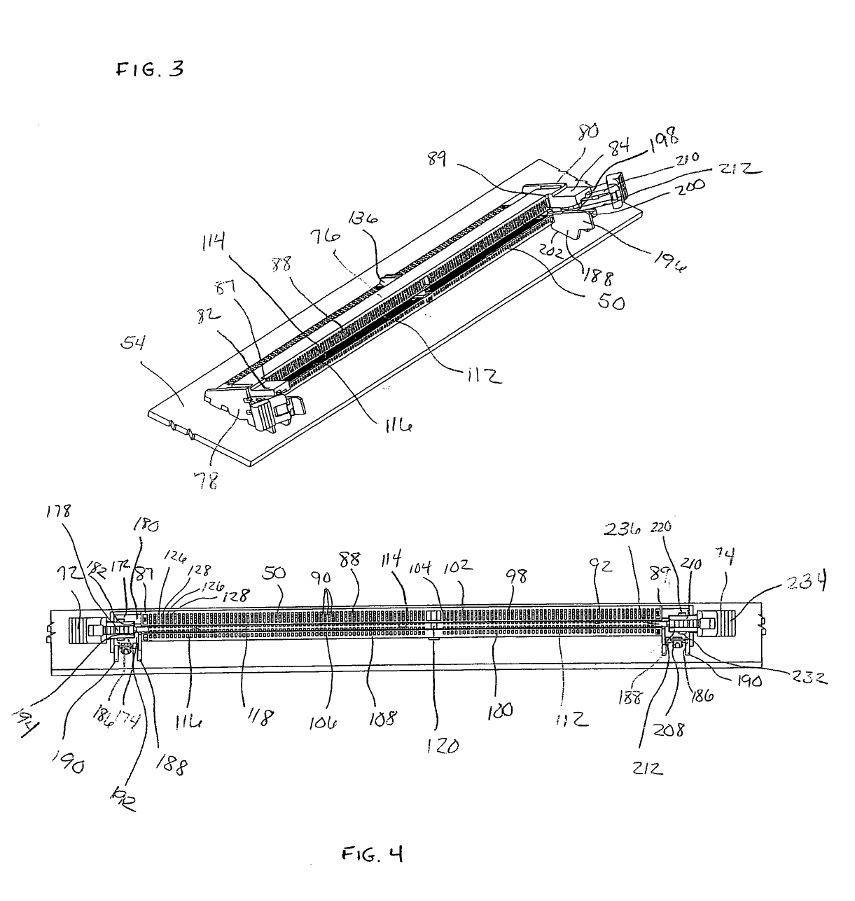

As best shown in FIGS. 3 and 4, the notches 92 in the upright walls 90 are aligned to provide a rectangularly-shaped socket, or slot, 112 extending from the rear end 88 of the central base portion 76 and positioned between the upper and lower rails 98, 100. The slot 112 includes an upper wall 114 defined by the lower surfaces of the upper wall portions 94, a lower wall 116 defined by the upper surfaces of the lower wall portions 96, and an end wall 118 extending between the upper wall 114 and the lower wall 116 and spaced from the rear end 88 of the central base portion 76. As best shown in FIG. 9, the upper and lower walls 114, 116 of the slot 112 are generally parallel to each other and the end wall 18 is generally perpendicular to the upper and lower walls 114, 116.

A key 120 is positioned along the central base portion 76 of the connector housing 66. As best shown in FIGS. 18-20, the key 120 includes a right side wall 122, a left side wall 124 and an end surface 127. The left and right side walls 122, 124 are spaced apart and generally parallel to each other. The end surface 127 extends from the right side wall 122 to the left side wall 124 and is generally arc shaped. As best shown in FIG. 4, the key 120 extends from the lower wall 116 of the slot 112 to the upper wall 114 of the slot 112. The key 120 is optionally formed from metal and is used to provide alignment of the daughterboard 52 with the slot 112 as will be described herein.

A plurality of alternating first and second terminal passages 126, 128 are provided between the upright walls 90 and extend from the top wall 102 of the upper rail 98 to the bottom wall 108 of the lower rail 100. Each terminal passageway 126, 128 is defined by adjacent surfaces of the upright walls 90, the top wall 102 of the upper rail 98 and the bottom wall 108 of the lower rail 100. An upper pair of grooves 130 which form an enlarged slot and a lower pair of grooves 132 which form an enlarged slot are provided along the surfaces of each terminal passageway 126 for engagement with terminals 271, 275 as will be described herein. An upper pair of grooves 131 which form an enlarged slot and a lower pair of grooves 133 which form an enlarged slot are provided along the surfaces of each terminal passageway 128 for engagement with terminals 273, 277 as will be described herein. Each second terminal passageway 128 includes a rib 134 extending between the adjacent upright walls 90 and positioned between the upper pair of grooves 131 and the lower pair of grooves 133.

As best shown in FIGS. 16 and 16b, a generally triangularly-shaped brace member 136 extends from the front end 86 of the central base portion 76. The brace 136 includes an upper surface 138, a lower surface 140 and a free end 142. The upper surface 138 is planar with the top wall 102 of the upper rail 98. A tail aligner protrusion (not shown) extends downwardly from the lower surface 140 of the brace 136 proximate the free end 142 thereof.

Attention is invited to FIG. 2. The right base portion 78 extends from the right end 87 of the central base portion 76 and the left base portion 80 extends from the left 89 of the central base portion 76. The right and left base portions 78, 80 are mirror images of one another and, therefore, only the right base portion 78 will be described.

The right base portion 78 includes an upper wall 144 extending from the top wall 102 of the upper rail 98 of the central base portion 76 and a lower wall 146 extending from the bottom wall 108 of the lower rail 100 of the central base portion 76. A rearwardly extending channel 150 is provided in the upper wall 144. A cylindrically-shaped post aperture 152 is provided at the end of the channel 150. The lower wall 146 also includes a cylindrically-shaped post aperture (not shown) which is aligned with the post aperture 152. The upper wall 144 and lower wall 146 are joined together proximate the front ends thereof by a support member 148. A triangularly-shaped end plate 154 is provided at the outer end of the base portion 78. The end plate 154 includes a top surface 156, a bottom surface 158, a rear surface 160 and an outer surface 162. A front notch 164, a central notch 166 and a rear notch 168 are provided along the bottom surface 158 of the end plate 154. The top surface 156 of the end plate 154 is planar with the top wall 102 of the central base portion 76. The rear surface 160 is perpendicular to the top surface 156. The top surface 156 is angled relative to the bottom surface 158 at an angle of approximately 28.5 degrees. As a result, the bottom surface 158 is angled relative to the bottom wall 108 of the lower rail 100. A front end 170 of the end plate 154 extends forwardly of the front end 86 of the central base portion 76 and forwardly of the front end support member 148.

The right tower 82 extends rearwardly from the right base portion 78 and the left tower 84 extends rearwardly from the left base portion 80. The right and left towers 78, 80 are mirror images of each other and therefore only the right tower 82 will be described. As best shown in FIGS. 4, 5 and 6, the right tower 82 includes an upper guide member 172 extending rearwardly from the upper wall 144 of the right base portion 78 and a lower guide member 174 extending rearwardly from the lower wall 146 of the right base portion 78. The upper and lower guide members 172, 174 are spaced apart such that a channel 176 is provided there between the upper and lower guide members 172, 174. A support member 178 extends rearwardly from the right base portion 78 between the upper and lower guide members 172, 174 and within the channel 176.

As best shown in FIG. 4, the upper guide member 172 is generally rectangularly-shaped and includes an enlarged inner end 180 which is wider than the remainder of the upper guide member 172. The inner end 180 and the remainder of the upper guide member 172 form a shoulder 182 which provides a latch stop which will be described herein.

The lower guide member 174 includes a center portion 186, an inner foot 188 and an outer foot 190. The center portion 186 includes an enlarged inner end 192 which is wider than the remainder of the center portion 186. The inner end 192 and the remainder of the center portion 186 form a shoulder 194 which provides a latch stop which will be described herein. The inner foot 188 is provided proximate the inner end 192 of the center portion 186. As best shown in FIG. 3, the inner foot 188 is generally triangularly shaped with a rearwardly extending protrusion 196. The inner foot 188 includes a guide surface 198, a pre-alignment surface 200 and a base surface 202. The guide surface 198 of the inner foot 188 is planar with the lower wall 116 of the slot 112 and a portion of the guide surface 198 extends rearwardly of the upper guide member 172. The pre-alignment surface 200 extends from the rear end of the guide surface 198 and is angled rearwardly and downwardly relative to the guide surface 198. The guide surface 198 is angled 28.5 degrees relative to the base surface 202, which contacts the printed wiring board 54 as will be described herein. The outer foot 190 is provided proximate an outer end of the center portion 186. As best shown in FIG. 5, the outer foot 190 includes an upper surface 204 and a base surface 206. The upper surface 204 is generally parallel to the guide surface 198 of the inner foot 188. The upper surface 204 is angled 28.5 degrees relative to the base surface 206 which contacts the printed wiring board 54 as will be described herein.

A mechanical attach 208 extends downwardly from the center portion 186 of the lower guide member 174 and is positioned between the inner and outer feet 188, 190. The mechanical attach 208 is preferably formed from an electrically conductive material.

The right ejection latch member 72 is pivotally mounted to the right base portion 78 and the left ejection latch member 74 is pivotally mounted to the left base portion 80. The right and left latch members 72, 74 are identical. As best shown in FIG. 4, each latch member 72, 74 includes spaced parallel upper and lower arms 210, 212. An upper post 220 extends from the upper arm 210 and is positioned within the post aperture 152 of the upper wall 144 of the base portion 76. A lower post 232 extends from the lower arm 212 and is positioned within the post aperture of the lower wall 146 of the base portion 76. Rear ends of the upper and lower latch arms 210, 212 extend rearwardly of the tower 82 and a thumb platform 234 joins the rear ends together. The thumb platform 234 is generally perpendicular to the upper and lower arms 210, 212 but includes a sloped gripping surface. A stop member 236 joins front ends of the upper and lower arms 210, 212. The upper arm 210 of the latch member 72 is positioned above the support member 178 and the lower arm 212 is positioned below the support member 178 of the tower 82. The latch arms 72, 74 pivot outwardly and inwardly about the upper and lower posts 220, 232.

The tail aligner 70 is generally rectangularly-shaped and planar. As best shown in FIG. 1, the tail aligner 70 generally includes an upper surface 238, a lower surface 240, a right end 242 and a left end 244. A notch is provided at right and left ends 242, 244 to form a front tab 246 and a rear tab 248. The front tabs 246 of the tail aligner 70 mate with the front notches 164 of the end plates 154 and the rear tabs 248 at the ends of the tail aligner 70 mate with the center notches 166 of the end plates 154 as will be described herein.

A plurality of passageways 250 are provided from the upper surface 238 to the lower surface 240 of the tail aligner 70. The passageways 250 are provided in four rows. A first row 252 of passageways 250 is provided proximate the front end 86 of the central base portion 76 of the housing 66; a second row 254 of passageways 250 is spaced forwardly from the first row 252 of passageways 250; a third row 256 of passageways 250 is spaced forwardly from the second row 254 of passageways 250; and a fourth row 258 of passageways 250 is spaced forwardly from the third row 256 of passageways 250. The first 252 and third 256 rows of passageways are aligned such that the apertures 250 in the third row 256 are aligned with apertures 250 in the first row 252. The second 254 and fourth 258 rows of passageways 250 are aligned such that apertures 250 in the second row 254 are aligned with apertures 250 in the fourth row 258. The first 252 and third 256 rows of passageways are offset from the second 254 and fourth 258 rows of passageways

As shown in FIG. 5, a post 260 which is positioned centrally along the length of the tail aligner 70 extends downwardly from the lower surface 240 of the tail aligner 70. As shown in FIG. 16b, an aperture 262 extends from the upper surface 238 to the lower surface 240 of the tail aligner 70 for receiving the tail aligner protrusion of the brace 136.

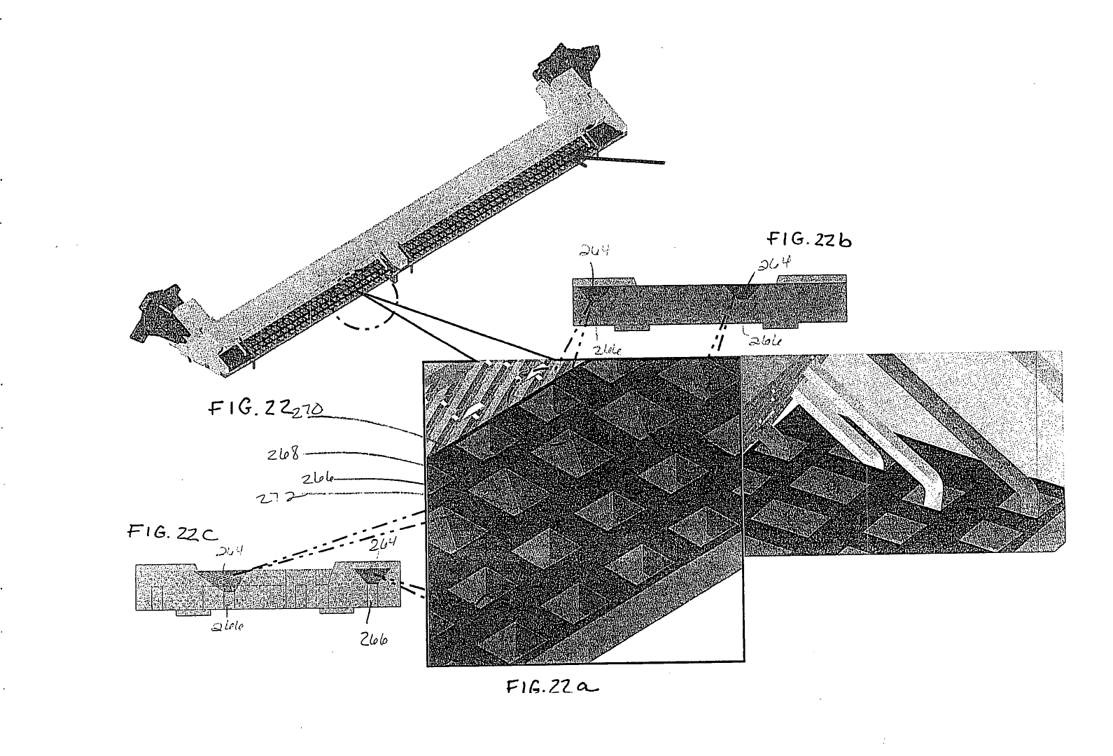

As shown in FIG. 22, the apertures 250 of the tail aligner 70 include upper and lower portions 264, 266. The lower portions 266 are generally rectangularly-shaped and are perpendicular to the upper and lower surfaces 238, 340 of the tail aligner 70. The upper portions 264 are tapered such that each aperture 250 is larger proximate the upper surface 238 of the tail aligner 70. More specifically, the upper portion 264 of each aperture 250 includes angled front 266, rear 268, right 270 and right 272 side walls which extend downwardly from the upper surface 238 of the tail aligner 70. The angled rear wall 268 of each aperture 250 accommodates a bending radius of the terminal 68 to be passed through the tail aligner 70 as described herein. The angle of the rear walls 268 relative to the walls of the lower portions 266 of the apertures 250 in the first 252 and second rows 254 of the tail aligner 70 is greater than the angle of the rear walls 268 of the apertures in the third 256 and fourth 258 rows of the tail aligner 70 with the angle of the rear walls 268 of the apertures in the second 254 row being greater and the angle of the rear walls 268 in the first row 252.

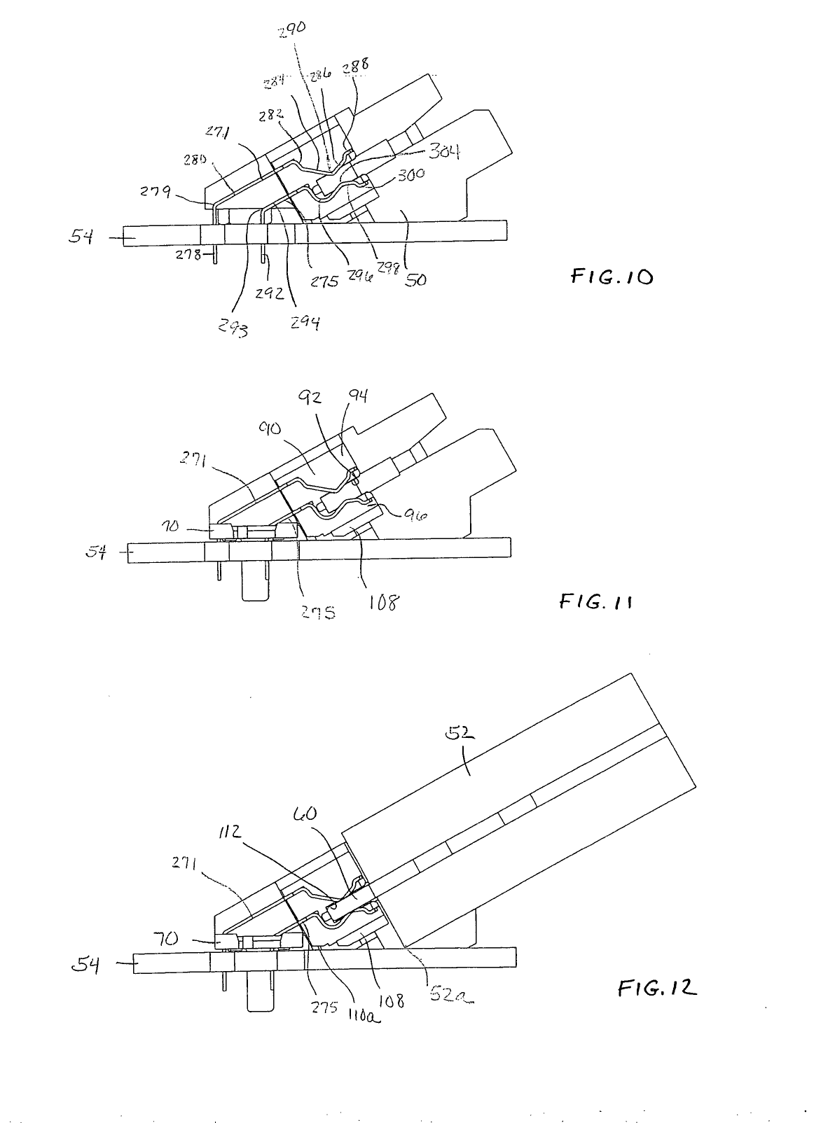

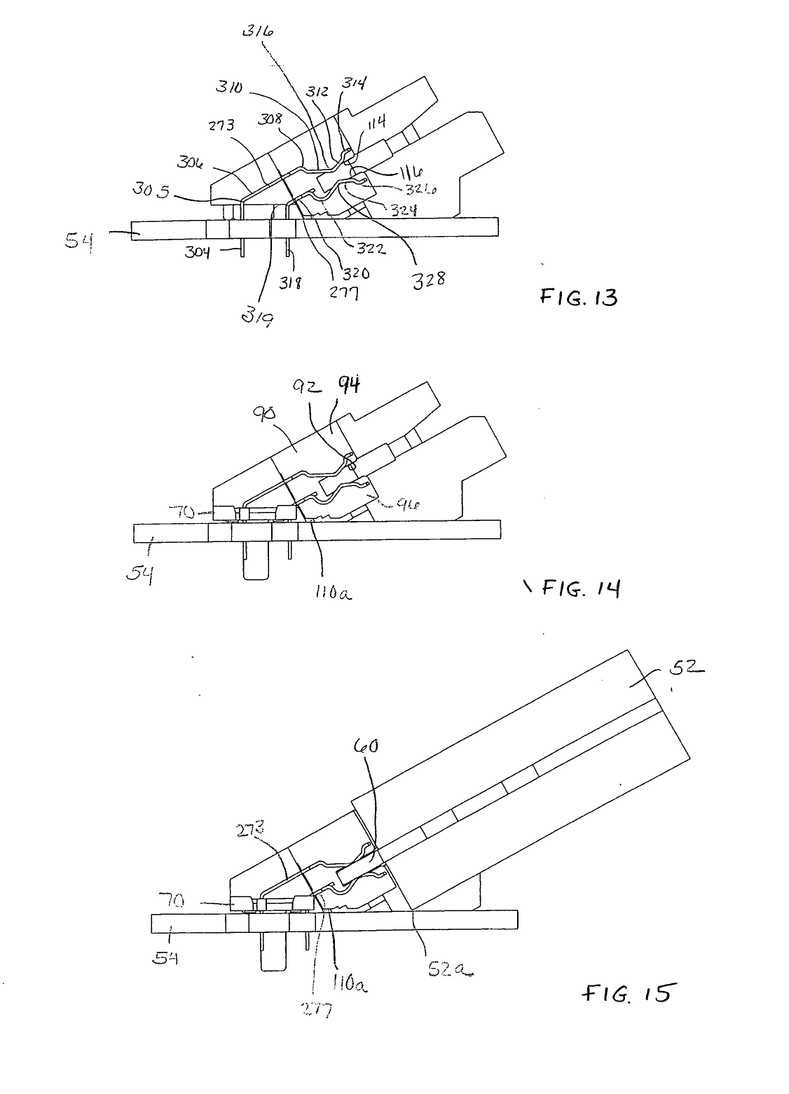

As best shown in FIGS. 7-16, a plurality of terminals 68 are mounted within the housing 66. The terminals 271, 273, 275, 277 are arranged in four rows. A first upper row 270 includes a plurality of terminals 271; a second upper row 272 includes a plurality of terminals 273; a first lower row of terminals 274 includes a plurality of terminals 275; and a second lower row of terminals 276 includes a plurality of terminals 277. Terminals 271 of the first upper row 270 and terminals 275 of the first lower row 274 extend through the first passageways 126 of the housing 66. Terminals 273 of the second upper row 272 and terminals 277 of the second lower row 276 extend through the second passageways 128 of the housing 66. The first and second upper rows of terminals 270, 272 extend from the upper rail 98 of the housing 66, forwardly of the front end 86 of the housing 66, through the tail aligner 70, and to the printed wiring board. The first and second lower rows 274, 276 of terminals extend from the lower rail 100 of the housing 66, forwardly of the front end 86 of the housing 66, through the tail aligner 70, and to the printed wiring board. Terminals 271 from the first upper row 270 and terminals 275 from the first lower row 274 are best shown in FIGS. 10-12. Terminals from the second upper row 272 and terminals from the second lower row 276 are best shown in FIGS. 13-15. The tail aligner 70 has been removed in FIGS. 7, 10 and 13 to more clearly show the terminals 68. As best shown in FIGS. 16-16b, the terminals 271 of first upper row 270 extend further in the forward direction than the terminals 273 of the second upper row 272; terminals 271 extend further in the forward direction than terminals,275 of the first lower row 274; and the terminals 275 of the first lower row 274 extend further in the forward direction than the terminals 277 of the second lower row 276.

As best shown in FIGS. 10-12, each terminal 271 in the first upper row 270 includes a first portion 278, a second portion 280, a third portion 282, a fourth portion 284, a fifth portion 286, and a sixth portion 288. The first portion 278 includes a first end and a second end and is generally perpendicular to the printed wiring board 54 to which the connector 50 is attached. The first portion 278 is mounted to the printed wiring board 54 and extends through the tail aligner 70. As shown, the first end of the first portion 278 is positioned below the lower surface 64 of the printed wiring board 54 and the second end of the first portion 278 extends above the upper surface 238 of the tail aligner 70. It is to be understood that the first portion 278 can be attached to the printed wiring board 54 in a number of ways, including surface mounting. The second portion 280 includes a first end and a second end. The first end of the second portion 280 extends from the second end of the first portion 278. The second portion 280 is angled relative to the first portion 278 such that the second portion 280 is generally parallel to the slot 112 and the second end of the second portion 280 is higher than the upper wall 114 of the slot 112. A corner 279 is provided between the first portion 278 and the second portion 280. As best shown in FIGS. 16a and 16b, the second portion 280 of the terminal includes outwardly protruding barbs 292 for engagement with the upper portions 94 of the upright walls 90. The third portion 282 includes a first end and a second end and is generally perpendicular to the second portion 280. The third portion 282 extends generally downwardly and rearwardly from the second end of the second portion 280. The fourth portion 284 extends from the second end of the third portion 282. The fourth portion 284 includes a first end and a second end and is angled downwardly and rearwardly relative to the third portion 282. The fifth portion 286 extends from the second end of the fourth portion 284 and includes a first end and a second end. The fifth portion 286 is angled relative to the fourth portion 284 such that the fifth portion 286 extends upwardly and rearwardly from the second end of the fourth portion 284. The second end of the fourth portion 284 and the first end of the fifth portion 286 form a contact corner 290 for mating with the contact pad of the daughterboard 52 to be inserted in the slot 112. The contact corner 290 extends below the upper wall 114 of the slot 112. The sixth portion 288 extends from the second end of the fifth portion 286 and includes a first end and a second end. The sixth portion 288 is angled relative to the fifth portion 286 such that the sixth portion 288 extends parallel to the slot 112. The second end of the sixth portion 288 is free.

Each terminal 275 of the first lower row 274 includes a first portion 292, a second portion 294, a third portion 296, a fourth portion 298, and a fifth portion 300. The first portion 292 includes a first end and a second end and is generally perpendicular to the printed wiring board 54 to which the connector 50 is attached. The first portion 292 extends through the printed wiring board 54 and through the tail aligner 70. The first end of the first portion 292 is positioned below the lower surface 64 of the printed wiring board 54 and the second end of the first portion 292 extends above the upper surface 238 of the tail aligner 70. The first portion 292 can be attached to the printed wiring board 54 in a number of ways, including surface mounting. The second portion 294 of the terminal includes a first end and a second end. The first end of the second portion 294 extends from the second end of the first portion 292. The second portion 294 is angled relative to the first portion 292 such that the second portion 294 is generally parallel to the slot 112 and the second end of the second portion 294 is higher than the lower wall 116 of the slot 112. A corner 293 is provided between the first portion 292 and the second portion 294. As best shown in FIGS. 16a and 16b, the second portion 294 of the terminal 275 includes outwardly protruding barbs 302 for engagement with the lower portions 96 of the upright walls 90. The third portion 296 includes a first end and a second end. The third portion 296 is generally hook-shaped and extends generally downwardly and rearwardly and then upwardly and rearwardly from the second end of the second portion 294. The fourth portion 298 extends from the second end of the third portion 296. The fourth portion 298 includes a first end and a second end and is angled downwardly and rearwardly relative to the third portion 296. The second end of the third portion 296 and the first end of the fourth portion 298 form a contact corner 304 for mating with the contact pad of the daughterboard 52 to be inserted in the slot 112. The contact corner 304 extends above the lower wall 116 of the slot 112. The fifth portion 300 extends from the second end of the fourth portion 298 and includes a first end and a second end. The fifth portion 300 is angled relative to the fourth portion 298 such that the fifth portion extends parallel to the slot 112. The second end of the fifth portion 288 is free.

As best shown in FIGS. 13-15, each terminal 273 in the second upper row 272 includes a first portion 304, a second portion 306, a third portion 308, a fourth portion 310, a fifth portion 3 12, and a sixth portion 314. The first portion 304 includes a first end and a second end and is generally perpendicular to the printed wiring board 54 to which the connector 50 is attached. The first portion 304 extends through the printed wiring board 54 and through the tail aligner 70. The first end of the first portion 304 is positioned below the lower surface 64 of the printed wiring board 54 and the second end of the first portion 304 extends above the upper surface 238 of the tail aligner 70. The first portion 304 of the terminals 273 can be connected to the printed wiring board in a number of ways, including surface mounting. As shown in FIGS. 7-9, the first portions 304 of the terminals 273 of the second upper row 272 are positioned rearwardly of the first portions 278 of the terminals 271 of the first upper row 270. The second portion 306 of the upper terminals 273 includes a first end and a second end. The first end of the second portion 306 extends from the second end of the first portion 304. The second portion 306 is angled relative to the first portion 304 such that the second portion 306 is generally parallel to the slot 112 and the second end of the second portion 306 is higher than the upper wall 114 of the slot but lower than the second portion 280 of the first upper terminals 271. A corner 305 is provided between the first portion 304 and the second portion 306. As best shown in FIGS. 16a and 16b, the second portion 306 of the terminal 273 includes outwardly protruding barbs 316 for engagement with the upper portions 94 of the upright walls 90. The third portion 308 of the terminal 273 includes a first end and a second end and extends generally downwardly and rearwardly from the second end of the second portion 306. The fourth portion 310 extends from the second end of the third portion 308. The fourth portion 310 includes a first end and a second end and is angled downwardly and rearwardly relative to the third portion 308. The fifth portion 312 extends from the second end of the fourth portion 310 and includes a first end and a second end. The fifth portion 312 is angled relative to the fourth portion 310 such that the fifth portion 312 extends upwardly and rearwardly from the second end of the fourth portion 310. The second end of the fourth portion 310 and the first end of the fifth portion 312 form a contact corner 316 for mating with the contact pad of the daughterboard 54 to be inserted in the slot 112. The contact corner 316 extends below the upper wall 114 of the slot 112. The sixth portion 314 extends from the second end of the fifth portion 312 and includes a first end and a second end. The sixth portion 314 is angled relative to the fifth portion 312 such that the sixth portion 314 extends parallel to the slot 112. The second end of the sixth portion is free.

Each terminal 277 of the second lower row 276 includes a first portion 318, a second portion 320, a third portion 322, a fourth portion 324, and a fifth portion 326. The first portion 318 includes a first end and a second end and is generally perpendicular to the printed wiring board 54 to which the connector 50 is attached. The first portion 318 extends through the printed wiring board 54 and through the tail aligner 70. The first end of the first portion 318 is positioned below the lower surface 64 of the printed wiring board 54 and the second end of the first portion 318 extends above the upper surface 238 of the tail aligner 70. The first portion 318 can be connected to the printed wiring board 54 in a number of ways, including surface mounting. The second portion 320 of the terminal 277 includes a first end and a second end. The first end of the second portion 320 extends from the second end of the first portion 318. The second portion 320 is angled relative to the first portion 318 such that the second portion 320 is generally parallel to the slot 112 and the second end of the second portion 320 is higher than the lower wall 116 of the slot 112. As best shown in FIGS. 16a and 16b, the second portion 320 of the terminal 277 includes outwardly extending barbs for engagement with the lower portions 96 of the upright walls 90. The third portion 322 of the terminal 277 includes a first end and a second end. The third portion 322 is generally hook-shaped and extends generally downwardly and rearwardly and then upwardly and rearwardly from the second end of the second portion 320. The fourth portion 324 extends from the second end of the third portion 322. The fourth portion 324 includes a first end and a second end and is angled downwardly and rearwardly relative to the third portion 322. The second end of the third portion 322 and the first end of the fourth portion 324 form a contact corner 328 for mating with the contact pad of the daughterboard 52 to be inserted in the slot 112. The contact corner 328 extends above the lower wall 116 of the slot 112. The fifth portion 326 extends from the second end of the fourth portion 324 and includes a first end and a second end. The fifth portion 326 is angled relative to the fourth portion 324 such that the fifth portion 326 extends parallel to the slot 112. The second end of the firth portion 326 is free.

As best shown in FIGS. 16, 16a, and 16b, each terminals 271 is mounted within grooves 130 of a terminal passageways 126 of the housing 66 such that the barbs 292 of each terminal 271 are placed within the upper pair of grooves 130 of the passageway 126 and the barbs engage the upper portions 94 of the upright walls 90. Each terminal 273 is mounted within grooves 131 of a terminal passageway 128 of the housing 66 such that the barbs 316 of each terminal 273 are placed within the upper pair of grooves 131 of a passageway 128 and the barbs engage the upper portions 94 of the upright walls 90. Each terminal 275 is mounted within grooves 132 of a passageway 126 of the housing 66 such that the barbs 302 of each terminal 275 are placed within the lower pair of grooves 132 of a passageway 126 and the barbs 302 engage the lower portions 66 of the upright walls 90. Each terminal 277 is mounted within grooves 133 of a passageway 128 of the housing 66 such that the barbs are placed within the lower pair of grooves 133 of a passageway 128 and the barbs engage the lower portions 96 of the upright walls 90.

The passageways 250 of the tail aligner 70 are then passed over the first portions of the terminals 271, 273, 275, 277 such that the first portions 278 of the terminals 271 pass through the fourth row 258 of passageways 250; the first portions 304 of the terminals 273 pass through the third row 256 of passageways 250; the first portions 292 of terminals 275 pass through the second row 254 of passageways 250; and the first portions 318 of the terminals 277 pass through the first row 252 of passageways 250. The angled rear walls 268 of the apertures 250 of the tail aligner 70 accommodate the bending radius between first and second portions of the terminals 271, 273, 275, 277. As best shown in FIG. 5, the front tabs 246 of the tail aligner 70 are positioned in the front notches 164 of the end plates 154 and the rear tabs 248 of the tail aligner 70 are positioned in the central notches 166 of the end plates 154 to secure the tail aligner 70 to the right and right end plates 154.

The connector 50 is mounted to the printed wiring board 54 by passing the post 260, the mechanical attaches 208 and first portions of the terminals 271, 273, 275, 277 through apertures in the printed wiring board 54. With the connector 50 mounted on the printed wiring board 54, the lower surfaces 158 of the end plates 154, the lower surfaces of the inner and outer feet 188, 190, and the lower surface 240 of the tail aligner 70 will contact the upper surface 26 of the printed wiring board 54.

The length and height of the tongue 60 of the daughterboard 52 are slightly smaller than the length and height of the slot 112 to allow the tongue 60 to be inserted in the slot 112. As shown in FIG. 17a, the tongue 60 of the daughterboard 52 is first positioned above the right and left towers 82, 84. Next, as shown in FIG. 17b, the daughterboard 52 is lowered until the lower surface 60a of the tongue 60 contacts the pre-alignment surfaces 200 of inner feet 188 of the towers 82, 84. Using the pre-alignment surfaces 200 as a guide, the rear end of the daughterboard 52 is then lifted so as to rotate the daughterboard 52, until the lower surface 60a of the tongue 60 contacts the guide surfaces 98 of the inner feet 188 and the daughterboard 52 is moved forward to insert the tongue 60 of the daughterboard 52 within the slot 112. Because the pre-alignment surfaces 200 and the guide surfaces 98 of the inner feet 188 extend rearwardly of the upper guide members 172, an individual inserting the daughterboard 52 within the slot 112 can easily observe the guide surfaces 98 and pre-alignment surfaces 200 from above the connector 50 and contact between the daughterboard 52 and the guide surfaces 98 and pre-alignment surfaces 200 can be achieved easily.

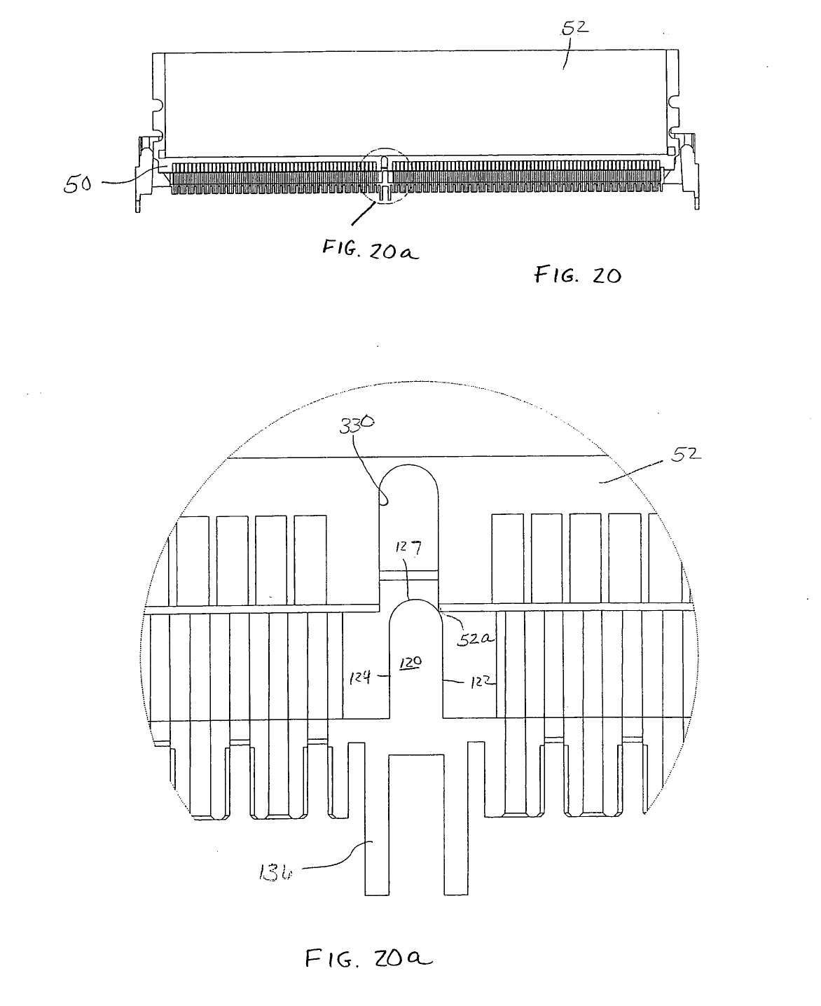

As shown in FIGS. 18-20, the daughterboard 52 includes a keyway 330 at the front edge thereof. The keyway 330 includes a right wall 332, a left wall 334, and an end wall 336. The right and left walls 332, 334 are generally parallel to each other. The rear ends of the right and left walls 332, 334 are joined by the end wall 336 which is arc shaped. As the daughterboard 52 is moved into the slot 112, the keyway 330 of the daughterboard 52 is aligned with the key 120 of the connector housing 66, such that the key 120 of the connector 50 is received in the keyway 330 of the daughterboard 52. As shown in FIGS. 19 and 19a, when the daughterboard 22 is inserted in the slot 112, the right wall 332 of the keyway 330 is positioned to the right of the right wall 122 of the key 120 and the left wall 334 of the keyway 330 is positioned to the left of the left wall 124 of the key 120. As shown in FIG. 20, when the keyway 330 of the daughterboard 52 is misaligned with the key 120 of the connector 50, the sharp front edge 52a of the daughterboard 52 contacts the end surface 127 of the key 120. As the daughterboard 52 is moved forward into the slot 112, the front edge 52a of the daughterboard 52 will follow along the end surface 127 of the key 120 until proper alignment between the key 120 and the keyway 330 is achieved. The key 120 is preferably formed from metal which has a hardness greater than the material from which the daughterboard 52 is formed, therefore, repeated contact between the key 120 and the daughterboard 52 will not result in deformation of the key 120. Although the connector 50 is shown with a key to aid in alignment of the daughterboard 52 with the connector 50, it is to be understood that the connector 50 can be provided without a key.

As best shown in FIGS. 9, 12, and 15, the angle of the slot 112 and the daughterboard 52 relative to the printed wiring board 54 is 28.5 degrees. The angle of the second portions 280, 294, 306, 320 of the terminals 68 relative to the printed wiring board 54 is also 28.5 degrees. Each of the terminals 68 are preferably formed from resilient thin metal strips or wires. As the daughterboard 52 is inserted into the slot 112, contact pads on the upper surface of the daughterboard 52 push against the corners 279 of the terminals 271 of the first upper row 270 causing the terminals 271 to deflect away from the slot 112. The second portions 280 of the terminals 271 are fixed to the upright walls 90 of the housing 66 through the outwardly protruding barbs 292 to maintain the terminals 271 within the passageways 126. Because the second portions 280 of the terminals 271 are positioned above the upper wall 114 of the slot 112, a spring like action is provided by the terminals 271 to maintain contact between the terminals 271 and the contact pads of the daughterboard 52.

As the daughterboard 52 is inserted into the slot 112, contact pads on the daughterboard 52 push against the corners 293 of the terminals 275 of the first lower row 274 causing the terminals 275 to deflect away from the slot 112. The second portions 294 of the terminals 275 are fixed to the upright walls 90 of the housing 66 through the outwardly protruding barbs 302 to maintain the terminals 275 within the passageways 126. Unlike the prior art connectors, which provide terminals of the lower row entirely below a plane parallel to the lower wall of the slot, the connector 50 provides the second portion 294 of each terminal 275 above a plane parallel with the lower wall 116 of the slot 112. The hook-shaped third portion 296 of each terminal 275 provides a portion which extends below a plane parallel with the lower wall 116 of the slot 112 and an upwardly extending portion. The third portion 296 of each terminal provides the spring like action which works to maintain contact between the corners 293 of the terminals 275 and the contact pads of the daughterboard 52.

As the daughterboard 52 is inserted into the slot 12, contact pads on the upper surface of the daughterboard 52 push against the corners 305 of the terminals 273 of the second upper row 272 causing the terminals 273 to deflect away from the slot 112. The second portions 306 of the terminals 273 are fixed to the upright walls 90 of the housing 66 through the outwardly protruding barbs 316 to maintain the terminals 273 within the passageways. 128. Because the second portions 306 of the terminals 273 are positioned above the upper wall 114 of the slot 112, a spring like action is provided by the terminals 273 to maintain contact between the terminals 273 and the contact pads of the daughterboard 52.

As the daughterboard 52 is inserted into the slot 112, contact pads on the lower surface of the daughterboard 52 push against the corners 328 of the terminals 277 of the first lower row 276 causing the terminals 277 to deflect away from the slot 112. The second portions 320 of the terminals 277 are fixed to the upright walls 90 of the housing 66 through the outwardly protruding barbs to maintain the terminals 277 within the passageways 128. The second portion 320 of the each terminal 277 is provided above a plane parallel with the lower wall 116 of the slot 112. The hook-shaped third portion 322 of each terminal 277 provides a portion which extends below a plane parallel with the lower wall 116 of the slot 112 and an upwardly extending portion. The third portion 322 of each terminal 277 provides the spring like action which works to maintain contact between the corners 328 of the terminals 277 and the contact pads of the daughterboard 52.

As best shown in FIG. 9, when the daughterboard 52 is positioned within the slot 112, the lowermost corners 52a of the daughterboard 52 are proximate the upper surface of the printed wiring board 54. Unlike the connector-daughterboard combination of the prior art which includes a gap between the lower most portion of the daughterboard and the printed wiring board, when the daughterboard 52 is mounted within the connector 50, little or no gap is provided between the printed wiring board 54 and the lower most corners 52a of the daughterboard 52. The minimization and/or elimination of this gap is due in part to the elimination of portions of the housing of the connector. As previously described, and as best shown in FIG. 21, the bottom wall 108 of the lower rail 100 is spaced from the front end of the housing 66. Thus, rather than joining the entire lower ends of the upright walls 90, portions of the lower ends of the walls 90 are not joined to provided free ends 110. The elimination of this portion of the bottom wall 108 allows the slot 112 to be positioned closer to the printed wiring board 54. In addition, providing angled surfaces 110a at each free end 110 allows the slot 112 to be positioned even closer to the printed wiring board 54. Although structure has been eliminated at the lower portion of the slot 112, the thickness of the upper rail 98 has been increased to provide additional support to the connector 50. The result is an offset slot 112 as best shown in FIGS. 3 and 4. This additional support and rigidity is achieved, without increasing the height profile of the connector-daughterboard combination 50, 52.

The elimination of the gap between the lower most corners 52a of the daughterboard 52 and the printed wiring board 54 is also due in part to the repositioning of the first and second lower terminals 275, 277. With portions of the housing 66 below the plane of the lower wall 116 of the slot 112 minimize, less area is provided to house the lower terminals 275, 277. Therefore, unlike the lower terminals of the prior art connector, the locking portions 294, 320 of the terminals 275, 277 are positioned above the plane of the lower wall 116 of the slot 112. Spring like action of the lower terminals 275, 277 is maintained by providing hook-shaped third portions 296, 322 which extend below the plane of the lower wall 116 of the slot 112.

The connector-daughterboard combination 50, 52 preferably has a height profile of 22 mm which provides a reduction in the height profile of the connector-daughterboard combination of approximately 2.5 mm relative to the prior art connector-daughterboard combinations. This result is achieved without altering the dimensions of the daughterboard 52. Thus, existing DIMM modules can be used with the connector 50 to provide the daughterboard 52 in an angled position while decreasing the profile of the combination.

Once the daughterboard 52 is positioned within the slot 112, the ejection latches 72, 74 are pivoted inwardly until the inner surfaces of the upper and lower arms 210, 212 of the latches 72, 74 contact the shoulders or latch stops 182, 192 of the upper and lower guide members 172, 174. When the daughterboard 52 is to be removed from the connector 50, the user places his thumbs on the thumb platforms 234 and pivots the ejection latch arms 72, 74 outwardly. As the arms 72, 74 are pivoted outwardly the stop members 236 at the front ends of the upper and lower arms 210, 212 engage the front end of the daughterboard 52 to push the daughterboard 52 rearwardly and out of the slot 112.

While a preferred embodiment of the present invention is shown and described, it is envisioned that those skilled in the art may devise various modifications of the present invention without departing from the spirit and scope of the appended claims.

The invention claimed is:

1. A card edge connector for attachment of a daughterboard to a printed wiring board comprising:
an insulative housing having a front end, a rear end, and a slot in said rear end to receive said daughterboard, wherein said slot is angled relative to the printed wiring board and a dimension of said housing above said slot is larger than a dimension of said housing below said slot; and
a plurality of terminal passageways extending from said slot to said rear end of said housing and capable of housing terminals.

2. A connector as defined in claim 1, wherein said housing further includes a key extending from said rear end thereof and is positioned within said slot.

3. A connector as defined in claim 2, wherein said key is a metal key.

4. A connector as defined in claim 1, wherein when said daughterboard is inserted in said slot, the distance from the printed wiring board to the uppermost portion of the daughterboard is 22 mm:

5. A connector as defined in claim 1, further including a tail aligner mounted to said housing, said tail aligner having an upper surface, a lower surface, and a plurality of passageways extending from said upper surface to said lower surface and wherein said terminals extend through said passageways of said tail aligner.

6. A connector as defined in claim 5, wherein said housing further includes a base member having end portions on opposite ends thereof and said tail aligner is mounted to said end portions.

7. A connector as defined in claim 5, wherein each said tail aligner passageway includes a rear wall, and wherein at least a portion of said rear wall is angled relative to said upper surface of said tail aligner.

8. A connector as defined in claim 1, wherein said slot includes upper and lower walls, said connector further including an upper guide member extending from said rear end and planar with said upper wall of said slot, and a lower guide member extending from said rear end and planar with said lower wall of said slot, said lower guide member extending rearwardly of said upper guide member.

9. A card edge connector for attachment of a daughterboard to a printed wiring board comprising:
an insulative housing including a front end, a rear end, a slot in said rear end having an upper and lower wall and angled relative to said printed wiring board and capable of receiving said daughterboard, an upper guide member extending from said rear end planar with said upper wall of said slot, and a lower guide member extending from said rear end planar with said lower wall of said slot, said lower guide member extending rearwardly of said upper guide member; and
a plurality of terminal passageways extending from said slot to said rear end of said housing and capable of housing terminals.

10. A card edge connector as defined in claim 9, wherein a dimension of said housing above said slot is larger than a dimension of said housing below said slot.

11. A card edge connector for attachment of a daughterboard to a printed wiring board comprising:
an insulative housing having a slot for receiving said daughterboard, said slot including an upper wall and a lower wall and being angled relative to said printed wiring board;
a plurality of upper terminals, each said upper terminal including a contact portion extending through said upper wall of said slot;
a plurality of lower terminals, each said lower terminal including a contact portion extending through said lower wall of said slot, wherein each lower terminal includes a locking portion to retain said lower terminal to said housing, said locking portion being positioned above a plane parallel to said lower wall of said slot.

12. A card edge connector as defined in claim 11, wherein the locking portion of each said lower terminal includes outwardly extending barbs.

13. A card edge connector as defined in claim 11, wherein each said upper terminal includes a locking portion to retain said upper terminal to said housing, said locking portion being positioned above a plane parallel to said upper wall of said slot.

14. A card edge connector as defined in claim 13, wherein the locking portion of each said upper terminal includes outwardly extending barbs.

15. A card edge connector as defined in claim 11, further including a plurality of upright walls having front, rear, upper and lower ends thereof, said upright walls defining a plurality of terminal passageways extending from said slot to said rear end of said housing and wherein at least a portion of each of said upper and lower terminals is positioned within one of said plurality of terminal passageways.

16. A card edge connector as defined in claim 15, wherein the locking portion of each said lower terminal includes outwardly extending barbs for engaging said upright walls.

17. A card edge connector as defined in claim 15, wherein the locking portion of each said upper terminal includes outwardly extending barbs for engaging said upright walls.

18. A card edge connector as defined in claim 13, further including a tail aligner having an upper surface, a lower surface and a plurality of passageways extending from said upper surface to said lower surface; and wherein each of said upper and lower terminals extends through a passageway of said tail aligner.

19. A card edge connector as defined in claim 18, wherein said passageways of said tail aligner are arranged in a first row proximate the front end of the housing, a second row spaced from said first row, a third row spaced from said second row and a fourth row spaced from said third row; and
wherein each said lower terminal extends through a tail aligner passageway of said first or second row and each said upper terminal extends through a tail aligner passageway of said third or fourth row.

20. A card edge connector for attachment of a daughterboard to a printed wiring board comprising:
an insulative housing having a slot to receive said daughterboard;
a plurality of terminal passageways for receiving terminals; and
a metal key extending from within said slot.
